(19) United States
(12) Patent Application Publication
(10) Pub. No.: US 2008/0292874 A1
(43) Pub. Date: Nov. 27, 2008

(54) Sintered power semiconductor substrate and method of producing the substrate

(75) Inventors: Christian GOBL, Nurnberg (DE); Heiko BRAML, Wiesenttal (DE); Ulrich HERMANN, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: SEMIKRON Elektronik GmbH & Co. KG

(21) Appl. No.: 12/152,022

(22) Filed: May 12, 2008

(30) Foreign Application Priority Data
May 12, 2007 (DE) 10 2007 022 337.6

(51) Int. Cl. B32B 18/00; B32B 5/00; B32B 38/14

(52) U.S. Cl. 428/335; 428/457; 428/472.2; 428/450; 156/277

(57) ABSTRACT

A power semiconductor substrate with an insulating sheet-like base, having at least one sequence of layers of: a thin adhesion promoting layer, a sintered metal layer and a conductive layer arranged on at least one main area of the substrate. The associated process includes the steps of: coating at least a portion of the one main area with the adhesion promoting layer; arranging a pasty layer of the sintered metal and a solvent on at least a portion of the adhesion promoting layer; arranging the conductive layer on the sintered metal layer; and applying pressure to the conductive layer of the power substrate.

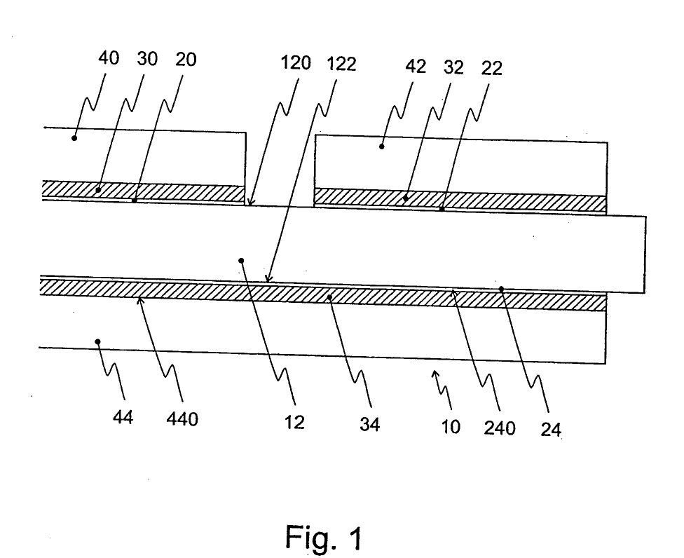

### BACKGROUND OF THE INVENTION

1. Field of the Invention

The invention is directed to a power semiconductor substrate with an insulating base and at least one conductor track and a method for producing such a substrate.

2. Description of the Related Art

Such power semiconductor substrates have so far been known for example in the form of AMB (active metal braze), DCB (direct copper bonding) or IMS (insulated metal substrate) substrates.

The at least one conductor track provides electrically conductive connection, for example, to power semiconductor devices or to internal and/or external connecting elements. Such connecting elements may be formed with the conductor track for example by means of soldering or brazing connections, or by means of pressure-contacted connections.

According to the prior art, there are known DCB substrates that comprise a ceramic base body, often aluminium oxide or aluminium nitride, with conductor tracks of a copper foil arranged thereon. U.S. Pat. No. 4,563,383 discloses for example known DCB substrates.

A disadvantage of such DCB substrates is that, due to the exposure to high temperature during the production process, immediately after the production process or in a later process step, for example during the buildup of a power semiconductor module, the substrate may become bowed. Values for this bowing that are known from tests are about 1% per unit of length. Depending on the intended use, a certain degree of bowing is acceptable, but it is common to most applications that the least possible bowing is advantageous.

### SUMMARY OF THE INVENTION

It is an object of the invention to provide a power semiconductor substrate with little bowing and a simple, low-cost method of producing such a power semiconductor substrate.

A power semiconductor substrate according to the invention has an insulating sheet-like base with at least one main area. Arranged on a main area is at least one sequence of layers comprising: a thin adhesion promoting layer, a sintered metal layer and a conductive layer. At least one of these sequences of layers forms a conductor track of the power substrate. It is also preferred if a plurality of these sequences of layers are formed on a first main area of the base so as to form the conductor tracks and a sequence of layers is arranged on a second main area and an unstructured contact layer is formed as a cooling component.

It is advantageous here if the sheet-like base is an industrial ceramic, such as, for example, aluminium oxide, aluminium nitrite or silicon nitrite.

Furthermore, it is advantageous if the adhesion promoting layer has a thickness of between about 0.5 μm and about 10 μm. Preferably, this adhesion promoting layer also has a precious metal surface that is, for example, electrodeposited and oriented to face the sintered metal layer. The sintered metal layer advantageously has a thickness of between about 5 μm and about 50 μm. It is preferred if at least 90% of the sintered metal layer 90 is a precious metal, for example silver.

Furthermore, it is preferred if the conductive layer is formed as a copper foil with a thickness of between about 100 μm and about 800 μm and has a precious metal surface oriented to face the sintered metal layer.

The inventive method for producing such a power semiconductor substrate includes the following steps:
coating at least a portion of at least one main area of the sheet-like insulating base with the adhesion promoting layer;
arranging a pasty layer of the sintered metal and a solvent on the adhesion promoting layer;
arranging the conductive layer on the sintered metal layer; and
applying pressure to the power substrate.

It may be preferred if the pasty layer is applied by means of screen printing. In this fashion, the necessary positioning accuracy can be achieved along with the required layer thickness, all at relatively low cost.

An advantageous way to apply pressure to the pasty layer may be to use a press and two press rams. It is preferred moreover if at least one press ram is formed with a silicone pad arranged thereon, thereby producing quasi-hydrostatic pressure.

It is preferred to arrange a film, preferably a Teflon film, on the power semiconductor substrate and subsequently apply pressure to this composite. Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The FIGURE is a stylized cross-section of the inventive substrate.

### DETAILED DESCRIPTION OF THE PRESENTLY PREFERRED EMBODIMENTS

Particularly preferred developments of this power semiconductor substrate and of the production process are described with reference to the exemplary embodiment illustrated in the FIGURE.

The FIGURE shows a power semiconductor substrate 10 according to the invention. The power semiconductor substrate 10 has an insulating base 12 having a sheet-like form. Base 12 should have a high electrical resistance with a low thermal resistance, for which reason an industrial ceramic, such as for example aluminium oxide, aluminium nitrite or silicon nitrite, is particularly suitable. A particularly good compromise of these requirements with low-cost production is offered by aluminium oxide.

In preparation for the following sintered connection, a thin film of an adhesion promoting layer 20, 22, 24 is applied to both main areas 120, 122 of base 12, preferably over its full surface area, the production process for this layer not being the subject of this invention. The adhesion promoting layer 20, 22, 24 has a preferred thickness of between about 0.5 μm and about 10 μm. Adhesion promoting layer 20, 22, 24 advantageously has a precious metal fraction of at least 90 percent. In addition or alternatively, with a different composition than the said composition, the adhesion promoting layer 20, 22, 24 has a precious metal surface, which is for example electrodeposited on the area 240 facing away from the base body 12.

It may furthermore be preferred to apply this adhesion promoting layer 20, 22, 24 over the full surface area of the main area or areas 120, 122 requiring further working and, in a further step of the process, to structure this adhesion promoting layer 20, 22, 24 according to the later form of the conductor tracks.

In a next step of the process, sintered metal layer 30, 32, 34 is applied with a layer thickness of between about 5 μm and about 50 μm, for example by means of a screen printing technique. At this point in time of the production process, sintered metal layer 30, 32, 34 comprises a pasty layer of the actual sintered metal and a solvent. The sintered metal is formed here as metal flakes with extents of the order of magnitude of micrometers.

Since the solvent is to be driven out of the pasty layer again in fractions of at least 90%, it is advantageous to expose substrate 10 to a temperature of between about 350 K and about 450 K for a suitable period of time before the sintering process begins.

In a next step, conductive layer 40, 42, 44 is arranged on the pasty layer or on sintered metal layer 30, 32, 34. In this exemplary embodiment, conductive layer 40, 42, 44 is a copper foil which is already structured according to the later form of the conductor tracks. For effective current conduction, conductive layer 40, 42, 44 has a thickness of between about 100 μm and about 800 μm.

For the effective formation of the sintered connection, the copper foil of conductive layer (40, 42, 44) is formed with a precious metal surface 440 oriented to face the sintered metal layer.

After the arrangement of conductive layer 40, 42, 44 on sintered metal layer 30, 32, 34, pressure is applied to conductive layer 40, 42, 44. It may be advantageous here to arrange a film, preferably a Teflon film, between conductive layer 40, 42, 44 and the pressing ram of the pressure device before the pressure is applied, in order to ensure that it can be easily detached after the pressure has been applied.

It has proven to be advantageous to apply a final pressure of more than 8 MPa and at the same time heat the power substrate 10 to a temperature of between about 350 K and about 600 K.

As an alternative to the production process described above, a sequence of layers comprising an adhesion promoting layer, a sintered metal layer and a conductive layer may also be applied over the full surface area of one or both sides of the base and, in a final step of the process, structured according to the requirements specified for the circuitry. Wet-chemical etching techniques are suitable for this.

One advantage of the power semiconductor substrate 10 according to the invention is that a durable and very high-quality connection is formed by the sintered connection of base 12 and conductive layer 40, 42, 44. Since the temperature exposure preferably does not exceed about 600 K in the course of the sintering process, thermally induced bowing of power semiconductor substrate 10 is much less than in the case of prior art production processes.

With regard to the materials required as well as the necessary installations, the production according to the invention corresponds to a pressure sintered connection for prior art power semiconductor devices. As a result, the production of such a power semiconductor substrate 10 is made possible particularly advantageously, because it can be performed simply and at low cost.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A power semiconductor substrate having an insulating sheet-like base and at least one main area comprising:
at least one sequence of layers comprising
a thin adhesion promoting layer,
a sintered metal layer; and
a conductive layer arranged on the at least one main area.

2. The power semiconductor substrate of claim 1, wherein the sheet-like base is formed of an industrial ceramic.

3. The power semiconductor substrate of claim 2, wherein said industrial ceramic is selected from the group consisting of aluminium oxide, aluminium nitrite and silicon nitrite.

4. The power semiconductor substrate of claim 1, wherein said adhesion promoting layer has a thickness of about between 0.5 μm and about 10 μm and include a precious metal surface facing said sintered metal layer.

5. The power semiconductor substrate of claim 1, wherein said sintered metal layer has a thickness of between about 5 μm and about 50 μm.

6. The power semiconductor substrate of claim 1, wherein said conductive layer is a copper foil having a thickness of between about 100 μm and about 800 μm and has a precious metal surface facing said sintered metal layer.

7. The power semiconductor substrate of claim 1, wherein said sintered metal layer has a thickness of between about 5 μm and about 50 μm.

8. The power semiconductor substrate of claim 7, wherein said conductive layer is a copper foil having a thickness of between about 100 μm and about 800 μm and has a precious metal surface facing said sintered metal layer.

9. The power semiconductor substrate of claim 1, wherein said conductive layer is a copper foil having a thickness of between about 100 μm and about 800 μm and has a precious metal surface facing said sintered metal layer.

10. The power semiconductor substrate of claim 9, wherein said adhesion promoting layer has a thickness of about between 0.5 μm and about 10 μm and include a precious metal surface facing said sintered metal layer.

11. A method for producing a power semiconductor substrate having an insulating sheet-like base and at least one main area, at least one sequence of layers comprising a thin adhesion promoting layer, a sintered metal layer and a conductive layer arranged on the at least one main area, the method comprising the steps of:
coating at least a portion of the main area with the adhesion promoting layer;
arranging a pasty layer of the sintered metal and a solvent on a portion of the adhesion promoting layer;
arranging the conductive layer on the sintered metal layer; and
applying pressure to the conductive layer.

12. The method of claim 11, wherein the pasty layer is applied by screen printing.

13. The method of claim 11, the pressure is applied by means of a press and two press rams, at least one press ram being formed with a silicone pad arranged thereon, producing quasi-hydrostatic pressure.

14. The method of claim 11, wherein the maximum final pressure when pressure is applied is at least 8 MPa.

15. The method of claim 7, further comprising the step of heating the power semiconductor substrate to a temperature of between about 350 K and about 600 K when the pressure is being applied.

16. The method of claim 7, further comprising the step of covering the power semiconductor substrate with a film before the pressure is applied.
